(19) United States
(12) Patent Application Publication
(10) Pub. No.: US 2025/0355251 A1
(43) Pub. Date: Nov. 20, 2025

(54) WAVEGUIDE INPUT COUPLER MULTIPLEXING TO REDUCE EXIT PUPIL EXPANSION RAY FOOTPRINT

(71) Applicant: GOOGLE LLC, Mountain View, CA (US)

(72) Inventors: Shreyas Potnis, Kitchener (CA); Daniel Adema, Kitchener (CA)

(21) Appl. No.: 18/862,846

(22) PCT Filed: May 3, 2023
(86) PCT No.: PCT/US2023/020764

§ 371 Date: Nov. 4, 2024

Related U.S. Application Data
(60) Provisional application No. 63/339,175, filed on May 6, 2022.

(51) Int. Cl. G02B 27/01

(52) U.S. Cl. CPC G02B 27/0172; G02B 2027/0123

(57) ABSTRACT

An eyewear display device expands a field of view by projecting display light at multiple ranges of input angles to a waveguide (600) employing multiple portions of an incoupler (514) or multiple incouplers (514, 414) corresponding to the different angular ranges of display light to guide light to an exit pupil expander (416) configured to receive the display light from the different angular ranges and an outcoupler (608) that are sized to fit within an eyeglasses lens. The display light that is input from the different angular ranges is guided by the incouplers to be overlapped at an exit pupil expander (or, in some embodiments, at multiple exit pupil expanders that are overlaid with each other) to reduce the total ray footprint at the exit pupil expander.

### BACKGROUND

Augmented reality (AR) display systems typically utilize an optical combiner that combines light from the real world and light from a display, which may represent computer-generated imagery or recorded imagery, for output toward at least one eye of a user. One common type of optical combiner is a waveguide (also commonly referred to as a “lightguide”) used to transfer light from a light source (e.g., a projector or micro-display) toward a user's eye, while being substantially transparent to incident light from the surrounding environment. Some display devices use one or more waveguides to guide display light from a micro-display to the user's eye. A waveguide typically includes an incoupler to couple display light projected by an image source such as a micro-display into the waveguide, an exit pupil expander configured to expand one or more dimensions of an eyebox, and an outcoupler to couple light out of the waveguide and direct the light at an eye relief distance from the waveguide forming an exit pupil within which a virtual image generated by the image source can be viewed by a user of the display device.

### BRIEF SUMMARY OF EMBODIMENTS

Embodiments are described herein in which an eyewear display device expands a field of view by projecting display light at multiple ranges of input angles to a waveguide employing multiple portions of an incoupler or multiple incouplers corresponding to the different angular ranges of display light to guide light to an exit pupil expander configured to receive the display light from the different angular ranges and an outcoupler that are sized to fit within an eyeglasses lens. The display light that is input from the different angular ranges is guided by the incouplers to be overlapped at an exit pupil expander (or, in some embodiments, at multiple exit pupil expanders that are overlaid with each other) to reduce the total ray footprint at the EPE.

In an embodiment, a system includes an image source configured to project light comprising an image and a waveguide configured to receive light from the image source. The waveguide includes a first incoupler to couple light corresponding to a first portion of a field of view received from the image source into the waveguide and a second incoupler to couple light corresponding to a second portion of the field of view different from the first portion received from the image source into the waveguide. In some embodiments, first incoupler is a region of a larger, single incoupler, and the second incoupler is another region of the larger, single incoupler.

In some embodiments, the waveguide also includes an exit pupil expander configured to receive light from the first incoupler and the second incoupler and expand one or more dimensions of an eyebox. The waveguide also includes an outcoupler configured to direct light from the exit pupil expander to an eye of a user.

In some embodiments, the first portion of the field of view corresponds to a right half of the field of view and the second portion of the field of view corresponds to a left half of the field of view.

In some embodiments, the first incoupler is offset from the second incoupler. In some embodiments, the image source includes a first projector configured to project light corresponding to the first portion of the field of view to the first incoupler. In some embodiments, the image source also includes a second projector configured to project light corresponding to the second portion of the field of view to the second incoupler.

In another embodiment, a method includes coupling, at a first incoupler of a waveguide, light corresponding to a first portion of a field of view from an image source to an exit pupil expander of the waveguide. The method further includes coupling, at a second incoupler of the waveguide, light corresponding to a second portion of the field of view different from the first portion from the image source to the exit pupil expander.

In some embodiments, the first incoupler comprises a first region of an incoupler and the second incoupler comprises a second region of the incoupler. In some embodiments, the method further includes receiving light from the first incoupler and the second incoupler at an exit pupil expander and expanding one or more dimensions of an eyebox and directing light from the exit pupil expander at an outcoupler to an eye of a user.

In some embodiments, the first portion corresponds to a right half of the field of view and the second portion corresponds to a left half of the field of view. In some embodiments, the first incoupler is offset from the second incoupler.

In some embodiments, the method further includes projecting light corresponding to the first portion of the field of view from a first projector to the first incoupler. In some embodiments, the method further includes projecting light corresponding to the second portion of the field of view from a second projector to the second incoupler.

In another embodiment, an eyewear display device includes a waveguide to receive light from an image source. The waveguide includes a first incoupler to couple light corresponding to a first portion of a field of view received from the image source into the waveguide and a second incoupler to couple light corresponding to a second portion of the field of view different from the first portion received from the image source into the waveguide.

In some embodiments, the first incoupler comprises a first region of an incoupler and the second incoupler comprises a second region of the incoupler. In some embodiments, the waveguide further includes an exit pupil expander to receive light from the first incoupler and the second incoupler and expand one or more dimensions of an eyebox and an outcoupler to direct light from the exit pupil expander to an eye of a user.

In some embodiments, the first portion corresponds to a right half of the field of view and the second portion corresponds to a left half of the field of view. In some embodiments, the eyewear display device further includes the image source. The image source includes a first projector to project light corresponding to the first portion of the field of view to the first incoupler and a second projector to project light corresponding to the second portion of the field of view to the second incoupler. In some embodiments, the first incoupler is offset from the second incoupler.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 is a diagram illustrating a rear perspective view of an augmented reality display device implementing multiple incouplers for different angular ranges of display light in accordance with some embodiments.

FIG. 2 illustrates a waveguide 200 including components disposed in relation to each other and a configuration 210 of the waveguide components in the context of a rear view of the lens of FIG. 1.

FIG. 3 is a diagram illustrating a k-space diagram of display light traveling through components of a waveguide and a corresponding x-space diagram of components of the waveguide in the context of a lens.

FIG. 4 is a diagram illustrating a k-space diagram of display light traveling through a first incoupler to an exit pupil expander and outcoupler of a multi-incoupler waveguide and a corresponding x-space diagram of components of the multi-incoupler waveguide in the context of a lens in accordance with some embodiments.

FIG. 5 is a diagram illustrating a k-space diagram of display light traveling through a first incoupler to an exit pupil expander and outcoupler of a multi-incoupler waveguide and a corresponding x-space diagram of components of the multi-incoupler waveguide in the context of a lens in accordance with some embodiments.

FIG. 6 is a diagram illustrating an x-space diagram of components of a multi-incoupler waveguide in accordance with some embodiments.

### DETAILED DESCRIPTION

Near-eye display systems such as eyewear display devices potentially have multiple practical and leisure applications, but the development and adoption of wearable electronic display devices have been limited by constraints imposed by the optics, aesthetics, manufacturing process, thickness, field of view (FOV), and prescription lens limitations of the optical systems used to implement existing display devices. For example, the geometry and physical constraints of conventional designs result in displays having relatively small FOVs and relatively large optical combiners.

The optical performance of an eyewear display device is an important factor in its design; however, users also care significantly about aesthetics of wearable devices. Independent of their performance limitations, many of the conventional examples of wearable heads-up displays have struggled to find traction in consumer markets because, at least in part, they lack fashion appeal. Thus, it is desirable to integrate waveguides in eyewear display devices in order to achieve the form factor and fashion appeal expected of the eyeglass and sunglass frame industry. Not only are smaller lightguides more aesthetically appealing, they are also lighter.

Generally, it is desirable for a display to have a wide field of view (FOV) to accommodate the outcoupling of light across a wide range of angles. A larger FOV can be achieved through a larger EPE and outcoupler. The exit pupil expander (EPE) and outcoupler of a waveguide typically include optical grating structures such as diffraction gratings, slanted gratings, blazed gratings, holograms, holographic optical elements (e.g., optical elements using one or more holograms), volume diffraction gratings, volume holograms, surface relief diffraction gratings, and/or surface relief holograms. Likewise, the EPE includes diffraction gratings in some embodiments that extend along one or more dimensions. In some embodiments, the outcoupler is configured as a transmissive diffraction grating that causes the outcoupler to transmit light and to apply designed optical function(s) to the light during the transmission. In some embodiments, the outcoupler is a reflective diffraction grating that causes the outcoupler to reflect light and to apply designed optical function(s) to the light during the reflection.

To efficiently direct light into the EPE, the incoupler must align with the EPE, and to produce a large field of view, the EPE must likewise be large. However, the ophthalmic lens shape of an eyewear display device constrains the size of the EPE. Combining exit pupil expansion and outcoupling into a single two-dimensional (2D) grating is used to save space for waveguides composed of surface relief gratings. However, for waveguides that are reflective, combined pupil expansion and outcoupling may not be possible.

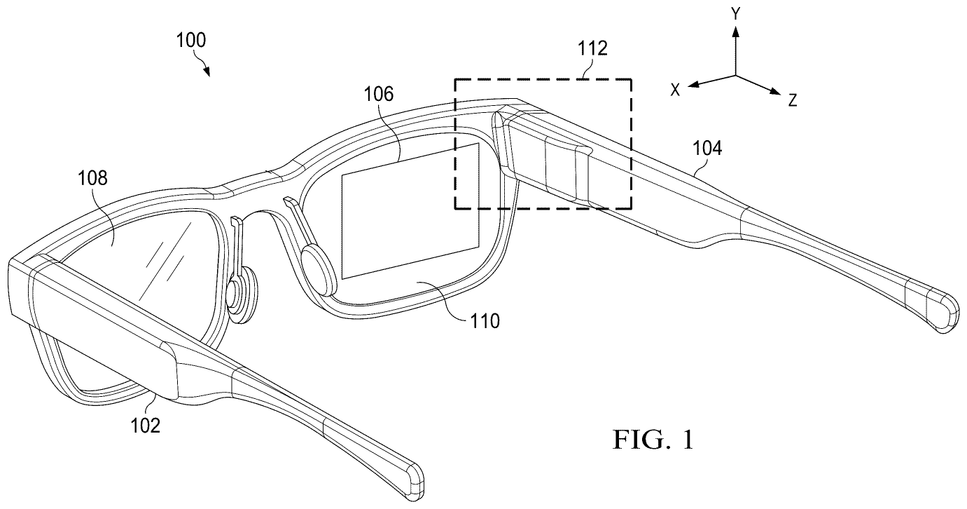

FIGS. 1-6 illustrate techniques for expanding a field of view of an eyewear display device by projecting display light at multiple ranges of input angles to a waveguide employing multiple portions of an incoupler or multiple incouplers corresponding to the different angular ranges of display light to guide light to an exit pupil expander configured to receive the display light from the different angular ranges and an outcoupler that are sized to fit within an eyeglasses lens. The display light that is input from the different angular ranges is guided by the incouplers to be overlapped at an exit pupil expander (or, in some embodiments, at multiple exit pupil expanders that are overlaid with each other) to reduce the total ray footprint at the EPE.

For example, in some embodiments, display light corresponding to the right half of the field of view is directed at a first range of input angles toward a first incoupler to a first EPE, which expands the exit pupil and directs the display light toward an outcoupler, which couples the display light for the right half of the field of view out of the waveguide toward the eye of a user. Meanwhile, display light corresponding to the left half of the field of view is directed toward a second incoupler at a second range of input angles to a second EPE that is overlaid with the first EPE and expands the exit pupil and directs the display light toward the outcoupler, which couples the display light for the left half of the field of view out of the waveguide toward the eye of the user.

In some embodiments, the first incoupler and the second incoupler correspond to different portions of a single, wide incoupler with different field points of light incident on different positions of the incoupler. In some embodiments, a first projector projects the display light at the first range of input angles and a second projector projects the display light at the second range of input angles. Thus, one portion of the field of view is projected by the first projector and another portion of the field of view is projected by the second projector.

FIG. 1 illustrates an example eyewear display system 100 implementing a waveguide having multiple incouplers for different angular ranges of display light to guide the display light to overlapping regions of one or more exit pupil expanders and to an outcoupler in accordance with implementations. The eyewear display system 100 includes a support structure 102 (e.g., a support frame) to mount to a head of a user and that includes an arm 104 that houses a laser projection system, micro-display (e.g., micro-light emitting diode (LED) display), or other light engine configured to project red, green and blue (RGB) display light representative of images toward the eye of a user, such that the user perceives the projected display light as a sequence of images displayed in a field of view (FOV) area 106 at one or both of lens elements 108, 110 supported by the support structure 102.

In some embodiments, the support structure 102 further includes various sensors, such as one or more front-facing cameras, rear-facing cameras, other light sensors, motion sensors, accelerometers, and the like. The support structure 102 further can include one or more radio frequency (RF) interfaces or other wireless interfaces, such as a Bluetooth™ interface, a WiFi interface, and the like. The support structure 102 further can include one or more batteries or other portable power sources for supplying power to the electrical components of the eyewear display system 100. In some embodiments, some or all of these components of the eyewear display system 100 are fully or partially contained within an inner volume of support structure 102, such as within the arm 104 in region 112 of the support structure 102. In the illustrated implementation, the eyewear display system 100 utilizes a spectacles or eyeglasses form factor. However, the eyewear display system 100 is not limited to this form factor and thus may have a different shape and appearance from the eyeglasses frame depicted in FIG. 1.

One or both of the lens elements 108, 110 are used by the eyewear display system 100 to provide an AR display in which rendered graphical content can be superimposed over or otherwise provided in conjunction with a real-world view as perceived by the user through the lens elements 108, 110. For example, laser light or other display light is used to form a perceptible image or series of images that are projected onto the eye of the user via one or more optical elements, including a waveguide, formed at least partially in the corresponding lens element. One or both of the lens elements 108, 110 thus includes at least a portion of a waveguide that routes display light received at different angular ranges corresponding to different portions of a field of view by two or more incoupler gratings (ICs) (not shown in FIG. 1) of the waveguide to an outcoupler grating (OC) (not shown in FIG. 1) of the waveguide, which outputs the display light toward an eye of a user of the eyewear display system 100. Additionally, the waveguide employs one or more exit pupil expander gratings (EPEs) in the light path between the ICs and OC in order to increase the dimensions of the display exit pupil. Moreover, each of the lens elements 108, 110 is sufficiently transparent to allow a user to see through the lens elements to provide a field of view of the user's real-world environment such that the image appears superimposed over at least a portion of the real-world environment.

In some embodiments, the display light is emitted by one or more digital light processing-based projectors, scanning laser projectors, or any combination of modulative light sources, such as a laser or one or more light-emitting diodes (LEDs), and a dynamic reflector mechanism such as one or more dynamic scanners, reflective panels, or digital light processors (DLPs). In some embodiments, the display light is emitted by one or more micro-display panels, such as a micro-LED display panel (e.g., a micro-AMOLED display panel, or a micro inorganic LED (i-LED) display panel) or a micro-Liquid Crystal Display (LCD) display panel (e.g., a Low Temperature PolySilicon (LTPS) LCD display panel, a High Temperature PolySilicon (HTPS) LCD display panel, or an In-Plane Switching (IPS) LCD display panel). In some embodiments, the display light is emitted by a Liquid Crystal on Silicon (LCOS) display panel. In some embodiments, a display panel (referred to as a display) is configured to output display light (representing an image or portion of an image for display) into the waveguide system of the eyewear display system 100. The waveguide system expands the light and outputs the light toward the eye of the user via the outcoupler.

The display is communicatively coupled to a controller and a non-transitory processor-readable storage medium or memory storing processor-executable instructions and other data that, when executed by the controller, cause the controller to control the operation of the display. In some embodiments, the controller is communicatively coupled to one or more processors (not shown) that generate content to be displayed at the eyewear display system 100. The projectors output display light corresponding to different portions of the FOV area 106 of the eyewear display system 100 via the waveguide system. In some embodiments, at least a portion of an outcoupler of the waveguide system overlaps the FOV area 106.

The waveguide maintains a relatively large FOV area 106 while constraining the size of the EPE to fit within one or more of the lens elements 108, 110 by dividing the FOV into two or more portions that are projected into the waveguide at different ranges of input angles via multiple incouplers (or multiple portions of a single, wide incoupler). The multiple incouplers direct the display light with overlapping ray footprints to one or more EPEs, which expand the exit pupil(s) of the display light and direct the display light to an outcoupler, which couples the light out of the waveguide toward the eye of a user. The overlapping ray footprint of the light enables the waveguide to maintain the large FOV area 106 while using one or more EPEs that do not exceed the size of the lens elements 108, 110.

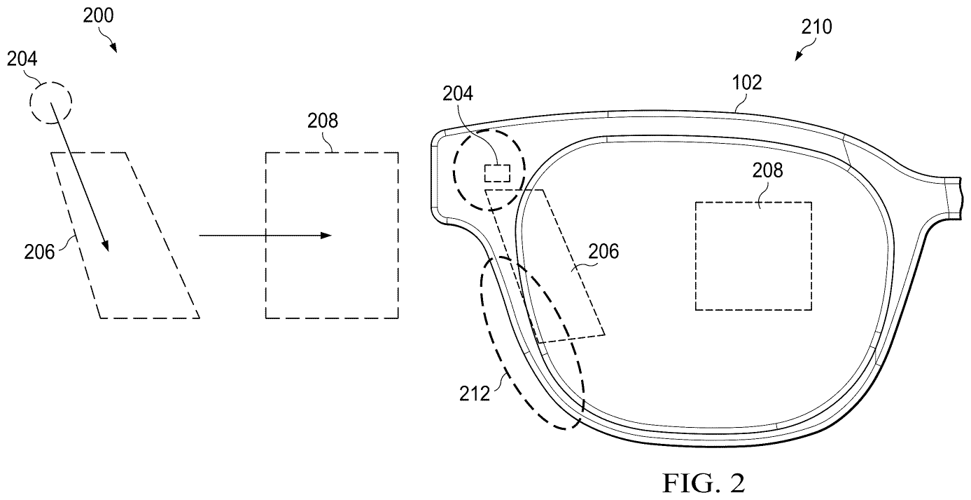

FIG. 2 illustrates a waveguide 200 including components disposed in relation to each other and a configuration 210 of the waveguide components in relation to a lens of a display device configured to be worn on the head of a user and that has a general shape and appearance of an eyeglasses frame. The components of the waveguide 200 include an incoupler (IC) 204, an exit pupil expander (EPE) 206, and an outcoupler (OC) 208. As shown, for the IC 204 to effectively couple display light into the EPE 206, the IC 204 and the EPE 206 are aligned. Similarly, for the OC 208 to effectively couple display light from the EPE 206 out of the waveguide to a user's eye, the EPE 206 and the OC 208 are aligned. Further, the size of the EPE 206 must generally expand to produce an expanded FOV.

However, as illustrated in configuration 210, due to the alignment of the IC 204 and the EPE 206, the size of the EPE 206 impacts the size and shape of the lens elements 108, 110. In some cases, the EPE 206 and OC 208 gratings must be cropped, e.g., at area 212, so that they fit within the boundaries of the lens elements 108, 110. Cropping the EPE 206 and OC 208 gratings reduces the eyebox size and usable FOV of the eyewear display system 100. However, enlarging the lens elements 108, 110 to accommodate larger gratings for the EPE 206 and OC 208 is constrained by aesthetic design considerations.

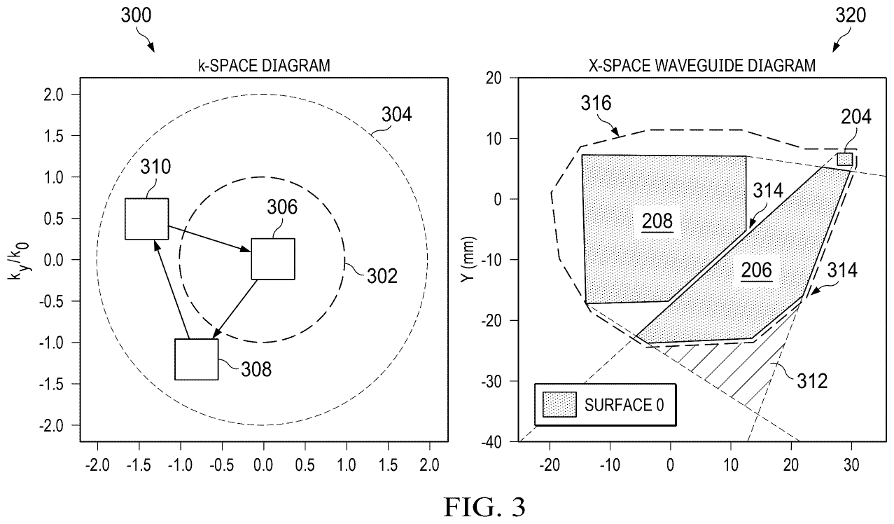

FIG. 3 illustrates a normalized k-space representation 300 of the display light propagating through the waveguide 200 and an x-space diagram 320 for a waveguide including an IC, an EPE, and an OC that are sized to achieve a 30-degree FOV. The k-space diagram is a tool used in optical design to represent directions of light rays that propagate within a waveguide. In the k-space representation 300, an inner refractive boundary 302 is depicted as a circle with radius of n=1, the refractive index associated with the external transmission medium (air). An outer refractive boundary 304 corresponds to an effective refractive index of the medium of the waveguide 200 of FIG. 2.

In the context of the k-space representation 300, for RGB display light to be successfully and accurately directed to an eye of a user via a waveguide (such as waveguide 200) with the indicated refractive index, each red, green, and blue component of that display light enters the waveguide system from an external position 306, which is included in the space depicted within inner refractive boundary 302. The color components are directed along one or more paths within the waveguide via total internal reflection (TIR) (light that undergoes TIR within the waveguide resides in the space depicted between inner refractive boundary 302 and outer refractive boundary 304) and are then redirected to exit the waveguide (and thereby return to the external space within inner refractive boundary 302 within which light does not undergo TIR). Display light components represented between the inner refractive boundary 302 and outer refractive boundary 304 are propagated to the user via the waveguide. Any display light components represented outside the outer refractive boundary 304 (of which there are none in the k-space representation 300) are non-propagating and cannot exist.

Initially, display light entering the waveguide at the incoupler (e.g., incoupler 204) forms an image that is centered at or around the origin of the k-space representation 300. The image is initially disposed at a first position 306 with respect to k-space. Upon redirection of the display light by the incoupler 204, the image is shifted in k-space to a second position 308, corresponding to a shift in the negative k_{y} and kₓ dimensions. Upon redirection of the display light by the exit pupil expander (e.g., exit pupil expander 206), the image is shifted in k-space to a third position 310, corresponding to a shift in the positive k_{y} dimension and the negative kₓ dimension. Upon redirection of the display light by the outcoupler (e.g., outcoupler 208), the image is shifted in k-space back to the first position 306, corresponding to a shift in the positive kₓ dimension. In the present example, it is assumed that the angle at which the display light enters the waveguide system via the incoupler 204 is the same as or substantially the same as (e.g., within 5% of) the angle at which the display light exits the waveguide via the outcoupler 208.

The k-space diagram 300 shows the angles at which light is coupled into the waveguide and the x-space diagram 320 illustrates the sizes of EPE 206 and OC 208 with respect to a lens 316 that are needed to achieve a 30-degree FOV. The hashed lines of the EPE 206 indicate portions 312 of the EPE 206 that are too large to fit within the lens 316 due to design constraints. In addition, the lower right corner 314 of the OC 208 would have to be cropped to fit with the EPE 206 within the lens 316.

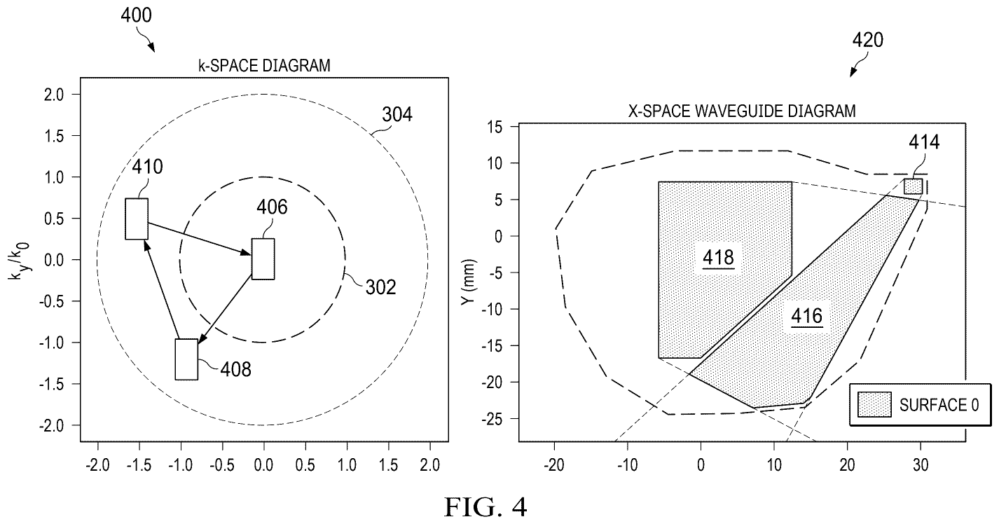

To minimize the extent to which the EPE 206 and OC 208 gratings are cropped to fit within the confines the lens 316 and therefore maintain a large FOV, some embodiments employ multiple ICs 204 for different angular ranges of light. Thus, a first IC couples light corresponding to a first portion of the FOV into the EPE 206 and a second IC offset from the first IC couples light corresponding to a second portion of the FOV into the EPE 206. In some embodiments, more than two ICs couple light corresponding to additional portions of the FOV into the EPE 206. In some embodiments, the image source that projects light into the waveguide through the multiple ICs is a single projector. For example, as illustrated in FIGS. 4-6, in some embodiments, a first IC couples light corresponding to the right half of the FOV into the EPE 206 and a second IC couples light corresponding to the left half of the FOV into the EPE 206. In some embodiments, multiple projectors corresponding to the multiple ICs project light into respective ICs. For example, in some embodiments, a first projector projects light into the first IC and a second projector projects light into the second IC.

FIG. 4 illustrates a k-space diagram 400 and a corresponding x-space diagram 420 for a waveguide including a first IC (IC1 414) configured to couple light corresponding to the right half of the FOV to the EPE 206. Similar to the k-space diagram 300, the image is initially disposed at a first position 406 with respect to k-space. Upon redirection of the display light by the incoupler, the image is shifted in k-space to a second position 408, corresponding to a shift in the negative k_{y} and kₓ dimensions. Upon redirection of the display light by the exit pupil expander, the image is shifted in k-space to a third position 410, corresponding to a shift in the positive k_{y} dimension and the negative kₓ dimension. Upon redirection of the display light by the outcoupler, the image is shifted in k-space back to the first position 406, corresponding to a shift in the positive kₓ dimension. However, as can be seen in the k-space diagram 400, only half the light compared to the k-space diagram 300 of FIG. 3 (i.e., the rectangle 406 corresponds to half of the square 306) is coupled into the waveguide. As illustrated in the x-space diagram 420 of FIG. 4, an EPE 416 and an OC 418 that are sized to receive, expand, and outcouple the light from the IC1 414 are cropped to a lesser extent than the EPE 206 and OC 208 illustrated in FIG. 3.

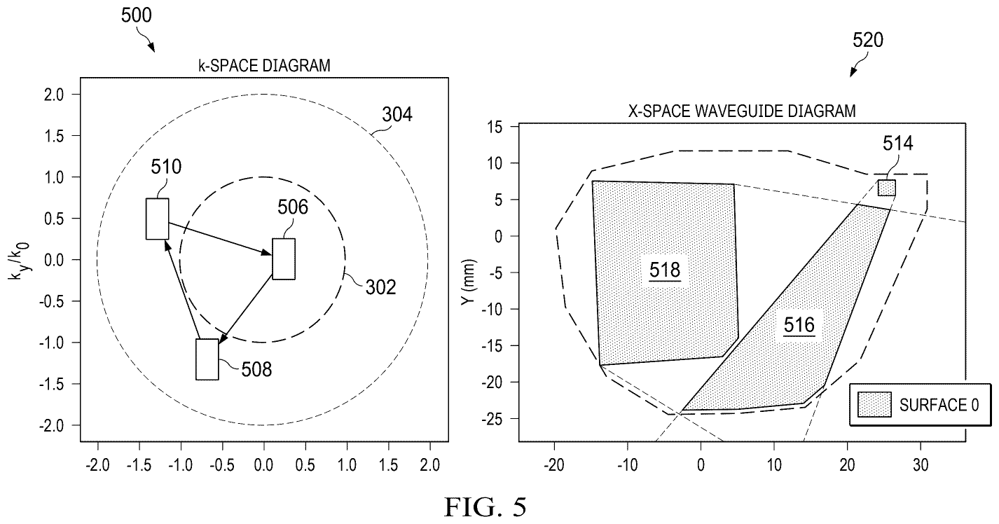

FIG. 5 illustrates a k-space diagram 500 and a corresponding x-space diagram 520 for a waveguide including a second IC (IC2 514) configured to couple light corresponding to the left half of the FOV to an EPE 516. Similar to the k-space diagrams 300 and 400, the image is initially disposed at a first position 506 with respect to k-space. Upon redirection of the display light by the incoupler, the image is shifted in k-space to a second position 508, corresponding to a shift in the negative k_{y} and kₓ dimensions. Upon redirection of the display light by the exit pupil expander, the image is shifted in k-space to a third position 510, corresponding to a shift in the positive k_{y} dimension and the negative kₓ dimension. Upon redirection of the display light by the outcoupler, the image is shifted in k-space back to the first position 506, corresponding to a shift in the positive kₓ dimension. As illustrated in the k-space diagram 500 of FIG. 5, only half the light compared to the k-space diagram 300 of FIG. 3 (i.e., the rectangle 506 corresponds to the other half of the square 306 from rectangle 406) is coupled into the waveguide. As shown in the x-space diagram 520 of FIG. 5, the EPE 516 and an OC 518 that are sized to receive, expand, and outcouple the light from the IC2 514 are cropped to a lesser extent than the EPE 206 and OC 208 illustrated in FIG. 3.

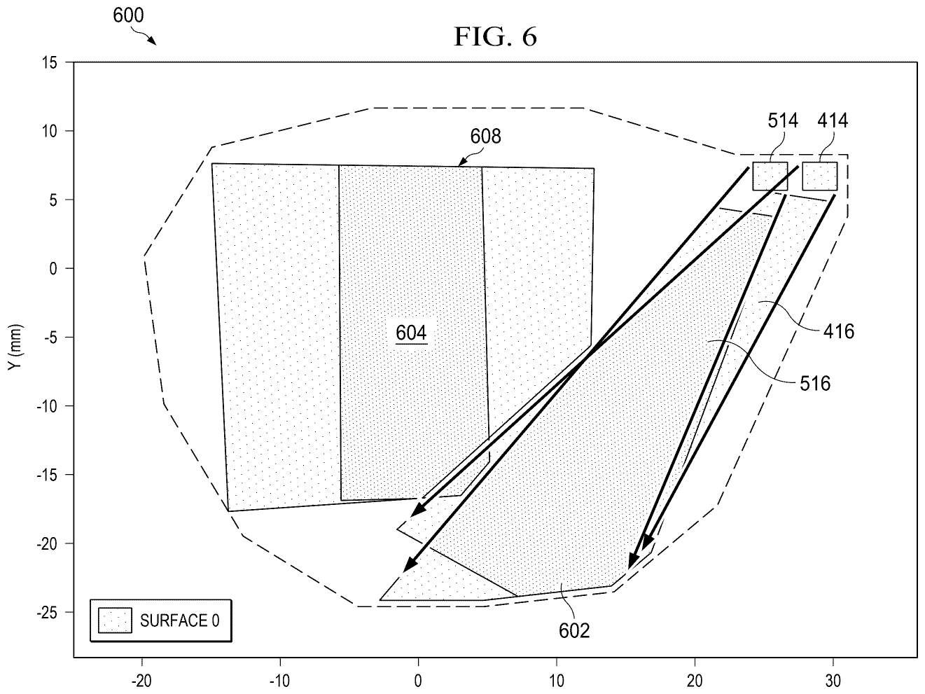

FIG. 6 illustrates a waveguide 600 including both IC1 414 and IC2 514 of FIGS. 4 and 5. As shown in FIG. 6, the waveguide 600 includes multiple incouplers—IC1 414 and IC2 514—that are offset from each other. IC1 414 couples light from a first portion of the FOV into the EPE 416 and IC2 514 couples light from a second portion of the FOV into the EPE 516. In the illustrated example, IC1 414 couples light from the right half of the FOV into the EPE 416 and IC2 514 couples light from the left half of the FOV into the EPE 516. In some embodiments, light is projected to both IC1 414 and IC2 514 at the same time. In some embodiments, light is projected to the regions of the FOV as needed, based on a user's known eye position (based, e.g., on eye-tracking). In some embodiments, EPE 416 and EPE 516 are separate EPEs that are overlaid with one another, and in other embodiments, EPE 416 and EPE 516 are portions of a single EPE. Because the light rays coupled into the EPE by each of IC1 414 and IC2 514 overlap, the EPE supports a large FOV even though the EPE is cropped to some extent to fit within the design parameters of the lens. The darker shaded portions 602, 604 of the EPE and the OC 608 indicate areas in which light coupled from the IC1 414 and light coupled from the IC2 514 overlap within the EPE and the OC 608. By multiplexing the waveguide incouplers, the ray footprint of light is reduced during exit pupil expansion, allowing a smaller EPE and OC to support a large FOV.

In some embodiments, certain aspects of the techniques described above may be implemented by one or more processors of a processing system executing software. The software comprises one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors

A computer readable storage medium may include any storage medium, or combination of storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disc, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

1. A system comprising:
an image source to project light comprising an image; and
a waveguide to receive light from the image source, the waveguide comprising:
a first incoupler to couple light corresponding to a first portion of a field of view received from the image source into the waveguide; and
a second incoupler to couple light corresponding to a second portion of the field of view different from the first portion received from the image source into the waveguide.

2. The system of claim 1, wherein the first incoupler comprises a first region of an incoupler and the second incoupler comprises a second region of the incoupler.

3. The system of claim 1, wherein the waveguide further comprises:
an exit pupil expander to receive light from the first incoupler and the second incoupler and expand one or more dimensions of an eyebox; and
an outcoupler to direct light from the exit pupil expander to an eye of a user.

4. The system of claim 1, wherein the first portion corresponds to a right half of the field of view and the second portion corresponds to a left half of the field of view.

5. The system of claim 1, wherein the first incoupler is offset from the second incoupler.

6. The system of claim 1, wherein the image source comprises a first projector to project light corresponding to the first portion of the field of view to the first incoupler.

7. The system of claim 6, wherein the image source further comprises a second projector to project light corresponding to the second portion of the field of view to the second incoupler.

8. A method, comprising:
coupling, at a first incoupler of a waveguide, light corresponding to a first portion of a field of view from an image source to an exit pupil expander of the waveguide; and
coupling, at a second incoupler of the waveguide, light corresponding to a second portion of the field of view different from the first portion from the image source to the exit pupil expander.

9. The method of claim 8, wherein the first incoupler comprises a first region of an incoupler and the second incoupler comprises a second region of the incoupler.

10. The method of claim 8, further comprising:
receiving light from the first incoupler and the second incoupler at an exit pupil expander and expanding one or more dimensions of an eyebox; and
directing light from the exit pupil expander at an outcoupler to an eye of a user.

11. The method of claim 8, wherein the first portion corresponds to a right half of the field of view and the second portion corresponds to a left half of the field of view.

12. The method of claim 8, wherein the first incoupler is offset from the second incoupler.

13. The method of claim 8, further comprising:
projecting light corresponding to the first portion of the field of view from a first projector to the first incoupler.

14. The method of claim 13, further comprising:
projecting light corresponding to the second portion of the field of view from a second projector to the second incoupler.

15. An eyewear display device, comprising:
a waveguide to receive light from an image source, the waveguide comprising:
a first incoupler to couple light corresponding to a first portion of a field of view received from the image source into the waveguide; and
a second incoupler to couple light corresponding to a second portion of the field of view different from the first portion received from the image source into the waveguide.

16. The eyewear display device of claim 15, wherein the first incoupler comprises a first region of an incoupler and the second incoupler comprises a second region of the incoupler.

17. The eyewear display device of claim 15, wherein the waveguide further comprises:
an exit pupil expander to receive light from the first incoupler and the second incoupler and expand one or more dimensions of an eyebox; and
an outcoupler to direct light from the exit pupil expander to an eye of a user.

18. The eyewear display device of claim 15, wherein the first portion corresponds to a right half of the field of view and the second portion corresponds to a left half of the field of view.

19. The eyewear display device of claim 15, further comprising the image source, wherein the image source comprises:
a first projector to project light corresponding to the first portion of the field of view to the first incoupler; and
a second projector to project light corresponding to the second portion of the field of view to the second incoupler.

20. The eyewear display device of claim 15, wherein the first incoupler is offset from the second incoupler.
